(19) United States
(12) Patent Application Publication
(10) Pub. No.: US 2009/0186709 A1
(43) Pub. Date: Jul. 23, 2009

(54) Mechanism for Transmitting Power Between Shaft and Hub

(75) Inventors: Masahiko Igarashi, Tochigi-ken (JP); Takeshi Mochizuki, Tochigi-ken (JP); Masanori Kosugi, Tochigi-ken (JP)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: Honda Motor Co., Ltd.

(21) Appl. No.: 11/990,116

(22) PCT Filed: Mar. 24, 2006
(86) PCT No.: PCT/JP2006/306039

§ 371 Date: Feb. 7, 2008

(30) Foreign Application Priority Data
Aug. 8, 2005 (JP) 2005-229517

(51) Int. Cl. F16D 1/06

(52) U.S. Cl. 464/149

(57) ABSTRACT

A shaft tooth section has a mountain section of a twisted shape crossing the axis of a shaft (mountain section of hub tooth section). The hub tooth section has the mountain section of a linear shape having a constant tooth thickness, and the inner diameter of the mountain section varies from an end section toward the shaft shank side. A first step expanding toward the hub tooth section side is formed in a valley section of the shaft tooth section. A second step recessed toward the opposite side of the shaft tooth section is formed in the mountain section of the hub tooth section. The start point (P1) of the first step and the start point (P2) of the second step are set at the positions separated by a predetermined distance (L4).

### TECHNICAL FIELD

The present invention relates to a power transmitting mechanism for transmitting rotary torque smoothly between two members comprising a shaft and a hub.

### BACKGROUND ART

On motor vehicles such as automobiles, there have been employed a set of constant velocity universal joints through the shaft for transmitting drive power from an engine through a shaft. Each constant velocity universal joint comprises an outer member, an inner member, and a torque transmitting member disposed between the outer and inner members for transmitting torque between the outer and inner members. The constant velocity universal joint includes a shaft/hub unit having a tooth assembly which comprises a shaft tooth section on the shaft and a hub tooth section on a hub, the shaft tooth section and the hub tooth section being held in mesh with each other.

In recent years, there have been demands for efforts to reduce circumferential backlash of constant velocity universal joints which is caused by the chattering, such as noise, vibration, etc. of the power transmitting system. Heretofore, attempts have been made to reduce backlash between the inner ring and the shaft with a constant velocity universal joint having shaft serrations tilted at a torsional angle. Depending on the direction of the torsional angle and the direction of the torque load, the mechanical strength and service life of the inner ring and the shaft are likely to vary from product to product.

In the art of gears, technical concepts for crowning tooth surfaces have been disclosed in Patent documents 1 through 3, for example.

Patent Document 4 reveals a shaft/hub unit having a tooth assembly for transmitting torque. The disclosed tooth assembly includes a shaft tooth section having a constant outside diameter in the longitudinal direction and a hub tooth section having a constant base diameter in the longitudinal direction. The shaft tooth section has a base diameter (dw1) and the hub tooth section has an inside diameter (Dn1) in a first region at a shaft end. The shaft tooth section also has a base diameter (dw2) and the hub tooth section has an inside diameter (Dn2) in a second region near a shaft shank. The base diameter (dw2) of the shaft tooth section and the inside diameter (Dn2) of the hub tooth section in the second region are set to respective values greater than the base diameter (dw1) of the shaft tooth section and the inside diameter (Dn1) of the hub tooth section in the first region (dw1<dw2, Dn1<Dn2).

Patent document 5 on a splined connection between a shaft member and an outer circumferential member discloses that the shaft member has, near a shaft shank thereof, a larger-diameter region where the diameter of the shaft member at the bottom lands between the teeth on the side of the shaft member is increased, and the teeth of the shaft member and the teeth of the outer circumferential member mesh with each other in the larger-diameter region.

The applicant of the present application has proposed a spline shaft wherein the crowning top is positioned where the stress is minimized when rotary torque is applied to a region where the spline shaft and a constant velocity universal joint mesh with each other, thereby preventing the stress from concentrating on certain regions and simplifying the overall structure of the spline shaft (see Patent document 5).

Patent document 1: Japanese Laid-Open Patent Publication No. 02-062461;

Patent document 2: Japanese Laid-Open Patent Publication No. 03-069844;

Patent document 3: Japanese Laid-Open Patent Publication No. 03-032436;

Patent document 4: Japanese Laid-Open Patent Publication No. 11-514079 (PCT); and

Patent document 5: Japanese Laid-Open Patent Publication No. 2000-097244

Patent document 6: Japanese Laid-Open Patent Publication No. 2001-287122

### DISCLOSURE OF THE INVENTION

It is a general object of the present invention to provide a power transmitting mechanism for a shaft and a hub, which can prevent stresses from concentrating on certain regions for increased static mechanical strength and fatigue strength.

According to the present invention, when rotary torque is applied to a shaft and a hub while a shaft tooth section and a hub tooth section are engaging each other, the axis of a peak of the shaft tooth section crosses the axis of the shaft at a predetermined angle, and the peak of the shaft tooth section and the peak of the hub tooth section abut against each other at an end of the shaft and a shaft shank of the shaft, thereby distributing stresses in a stress-concentrated region for increased shaft strength.

A changing point of the diameter of the valley of the shaft tooth section and a changing point of the inside diameter of the peak of the hub tooth section are set in respective positions which are offset by a predetermined distance, so that stresses are prevented from concentrating on the changing points of the diameters of the shaft tooth section and the hub tooth section.

For example, the valley of the shaft tooth section may have a first step region raised toward the hub tooth section, and the peak of the hub tooth section may have a second step region retracted away from the shaft tooth section, and a starting point of the first step region and a starting point of the second step region may be set in respective positions which are offset from each other by a predetermined distance. An appropriate stress relaxing effect is obtained if the first step region of the shaft tooth section has a tilt angle set to a value ranging from 5 degrees to 45 degrees.

According to the present invention, therefore, since the changing point of the diameter of the valley of the shaft tooth section and the changing point of the inside diameter of the peak of the hub tooth section are offset by the predetermined distance, stresses applied to the shaft tooth section are distributed to one of the changing points and the other changing point for thereby relaxing stress concentration. Inasmuch as the concentration of the stresses are relaxed and the stresses are distributed, the static mechanical strength and fatigue strength of the area where the shaft tooth section and the hub tooth section mesh with each other are increased.

According to the present invention, furthermore, different main load transmitting regions may be provided depending on the magnitude of a load applied to an area where the shaft tooth section and the hub tooth section mesh with each other. For example, if the magnitude of the load selectively represents a low load, a medium load, and a high load, then the main load transmitting regions for transmitting the low load, the medium load, and the high load, respectively, may be established in directions spaced successively toward the end and the shaft shank engaged respectively by the peak of the shaft tooth section and the peak of the hub tooth section, for thereby relaxing stress concentration on particular regions.

According to the present invention, moreover, when rotary torque is applied to the shaft and the hub while the shaft tooth section and the hub tooth section are engaging each other, an arcuate region of the shaft tooth section, which has a predetermined radius of curvature, and a step region of the hub tooth section cooperate with each other in distributing stresses applied to the area where the shaft tooth section and the hub tooth section engage each other, for thereby relaxing stress concentration. Specifically, the arcuate region provided in the valley of the shaft tooth section and extending, with the predetermined radius of curvature, toward the hub tooth section is effective to increase the diameter of the shaft tooth section on which stresses concentrate, so that the strength of the shaft can be increased.

According to the present invention, furthermore, when rotary torque is applied to the shaft and the hub while the shaft tooth section and the hub tooth section are engaging each other, a tapered region in the valley of the shaft tooth section and a step region on the peak of the hub tooth section cooperate with each other in distributing stresses applied to the area where the shaft tooth section and the hub tooth section engage each other, for thereby relaxing stress concentration. Specifically, the tapered region provided in the valley of the shaft tooth section and having a diameter progressively greater toward the hub tooth section is effective to increase the diameter of the valley of the shaft tooth section on which stresses concentrate, so that the strength of the shaft can be increased.

### BRIEF DESCRIPTION OF THE DRAWINGS

FIG. 1 is a perspective view, partly cut away, of a shaft/hub unit which incorporates a power transmitting mechanism according to an embodiment of the present invention;

FIG. 2A is an enlarged partial transverse cross-sectional view showing a shaft tooth section and a hub tooth section which are held in mesh with each other with no load applied thereto;

FIG. 2B is an enlarged partial transverse cross-sectional view showing a shaft tooth section and a hub tooth section which are held in mesh with each other with rotary torque applied thereto in the direction indicated by the arrow Y;

FIG. 3 is an enlarged partial longitudinal cross-sectional view in the axial direction of a shaft, showing a peak of the hub tooth section which engages in a valley of the shaft tooth section shown in FIG. 1;

FIG. 4 is an enlarged partial longitudinal cross-sectional view showing a first step region slanted at a smaller tilt angle θ of the shaft shown in FIG. 3;

FIG. 5 is an enlarged partial longitudinal cross-sectional view showing a tooth of the shaft tooth section whose outside diameter varies toward a shaft shank of the shaft shown in FIG. 4;

FIG. 6 is a diagram showing the relationship between the tilt angle θ of the first step region of the shaft toot section, stress relaxation, and productivity;

FIG. 7 is a characteristic curve diagram showing the relationship between stresses developed in a region where the shaft tooth section and the hub tooth section are held in mesh with each other, and positions where the stresses are measured;

FIG. 8 is an enlarged partial longitudinal cross-sectional view of a shaft/hub unit which incorporates a power transmitting mechanism according to another embodiment of the present invention, the view showing an arcuate region disposed in a valley of a shaft tooth section;

FIG. 9 is an enlarged partial longitudinal cross-sectional view of a shaft/hub unit which incorporates a power transmitting mechanism according to still another embodiment of the present invention, the view showing a tapered surface disposed in a valley of a shaft tooth section;

FIG. 10 is an enlarged partial longitudinal cross-sectional view showing a tapered surface disposed on an inner surface of a hub tooth section;

FIG. 11 is an enlarged partial longitudinal cross-sectional view showing an arcuate region disposed on an inner surface of a hub tooth section;

FIG. 12 is an enlarged partial longitudinal cross-sectional view showing a hub tooth section having a constant inside diameter; and

FIG. 13 is an enlarged partial longitudinal cross-sectional view showing a hub tooth section having a constant inside diameter.

### BEST MODE FOR CARRYING OUT THE INVENTION

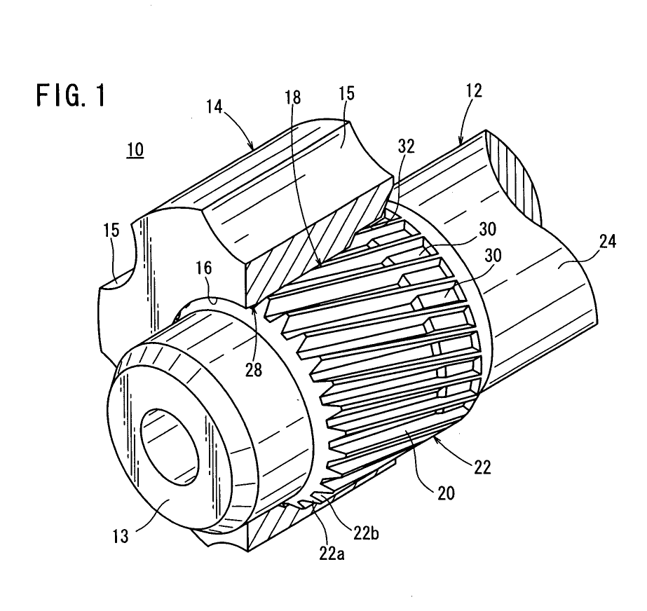

In FIG. 1, the reference numeral 10 denotes a shaft/hub unit which incorporates a power transmitting mechanism according to an embodiment of the present invention. The shaft/hub unit 10 serves as part of a constant velocity universal joint. The shaft/hub unit 10 comprises a shaft 12 functioning as a power transmitting shaft and a hub 14 functioning as an inner ring that has guide grooves 15 receiving therein balls (not shown) disposed in openings in an outer cup (not shown).

The shaft 12 has fitting portions 18 on its respective opposite ends each fitting in an axial hole 16 in the hub 14. In FIG. 1, only one end of the shaft 12 is shown, with the other end omitted from illustration. The fitting portion 18 has a shaft tooth section 22 comprising a plurality of straight spline teeth 20 which have a predetermined tooth length in the axial direction of the shaft 12 and which are formed successively in the circumferential direction of the shaft 12. Specifically, the shaft tooth section 22 comprises a circumferentially alternate succession of convex peaks 22a and concave valleys 22b.

The shaft 12 has a shaft shank 24 close to an end of the shaft tooth section 22 on the side of the center of the shaft 12. On the shaft 12 near an end 13 thereof, a retaining ring (not shown) is mounted in an annular groove (not shown) for preventing the hub 14 from being dislodged from the shaft 12.

When the shaft 12 is viewed radially inwardly (when the peaks 22a of the shaft tooth section 22 are viewed in plan), the shaft tooth section 22 has straight peaks 22a of a constant tooth thickness and valleys 22b whose diameters vary from the end 13 toward the shaft shank 24. The peaks 22a of the shaft tooth section 22 are of a twisted shape such that the axes of the peaks 22a cross the axis of the shaft 12 (the axes of peaks 28a of a hub tooth section 28) at a predetermined angle.

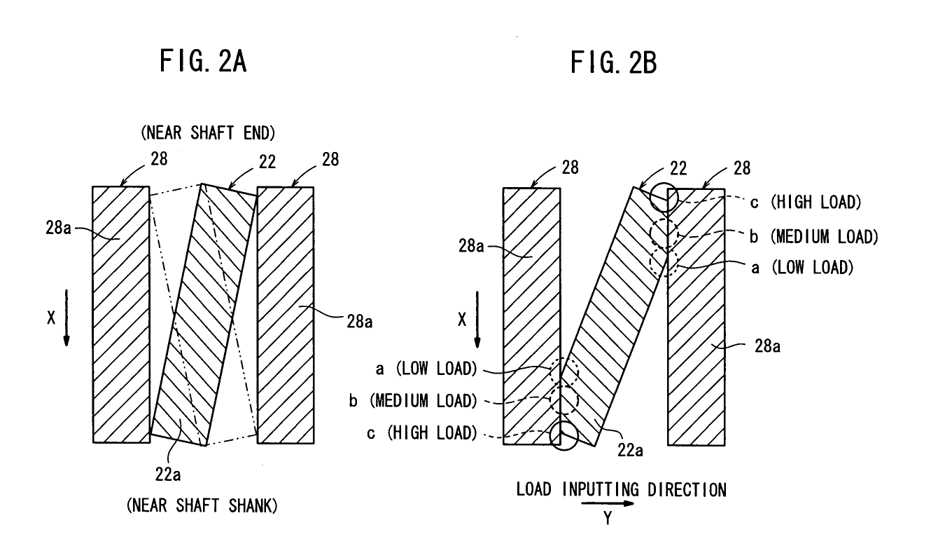

The hub 14 has, on the inner circumferential surface of the axial hole 16, a hub tooth section 28 having a plurality of straight spline teeth 26 that fit in the fitting portion 18 of the shaft 12. Specifically, the hub tooth section 28 comprises a circumferentially alternate succession of convex peaks 28a and concave valleys 28b. As shown in FIGS. 2A and 2B, the peaks 28a of the hub tooth section 28 have the same tooth thickness and extend parallel to the axis of the shaft 12, respectively.

As shown in FIGS. 2A and 2B, the peaks 22a of the shaft tooth section 22 and the peaks 28a of the hub tooth section 28 abut against each other at the end 13 and the shaft shank 24 of the shaft 12, so that the load will be distributed to the end 13 and the shaft shank 24 of the shaft 12.

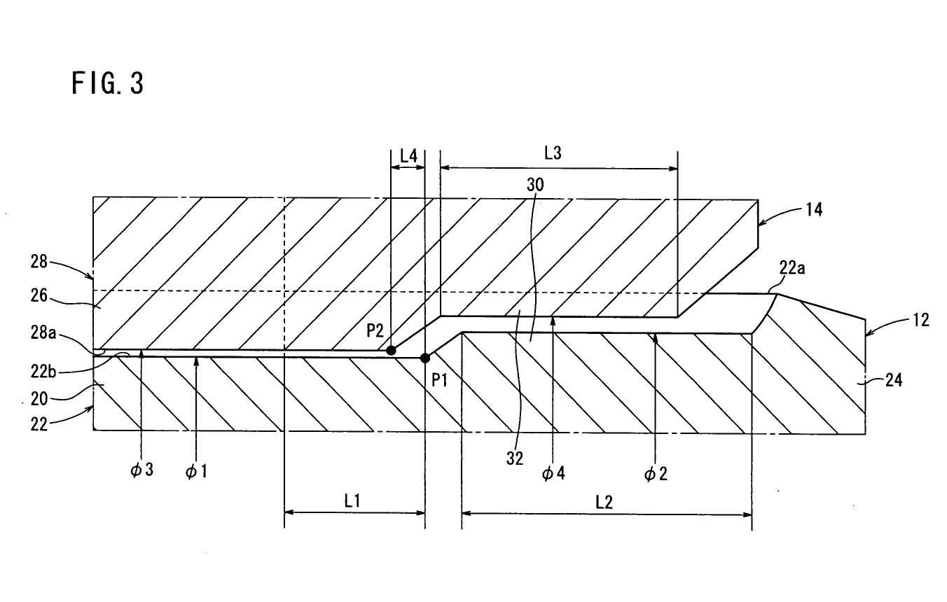

FIG. 3 is an enlarged partial longitudinal cross-sectional view in the axial direction of the shaft 12, showing the peak 28a of the hub tooth section 28 which engages in the valley 22b of the shaft tooth section 22.

A point P1 (changing point) is established which is displaced horizontally a predetermined distance L1 toward the shaft shank 24 from a position (see the broken line) in the valley 22b (valley diameter φ1) of the shaft tooth section 22. From the point P1, the valley 22b is raised toward the hub tooth section 28, providing a first step region 30 having a valley diameter φ2. The first step region 30 extends a predetermined distance L2 toward the shaft shank 24 and is joined to the shaft shank 24.

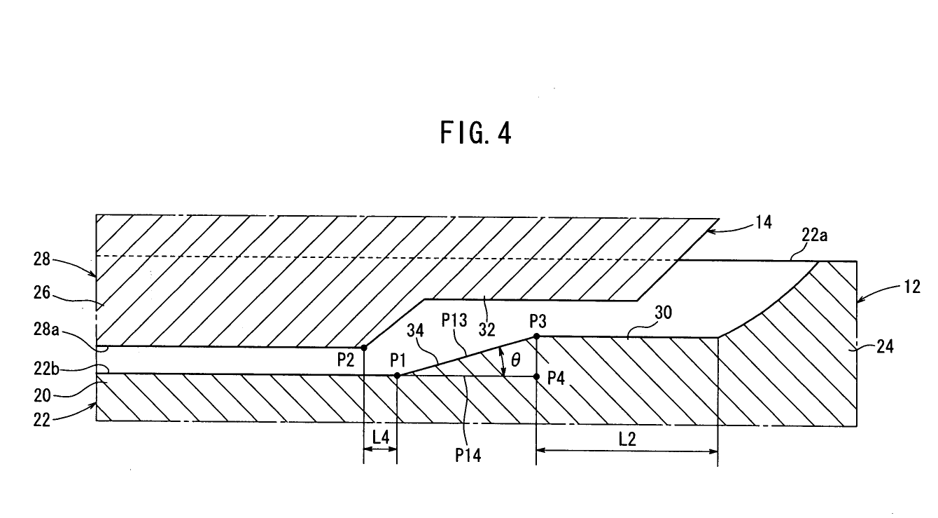

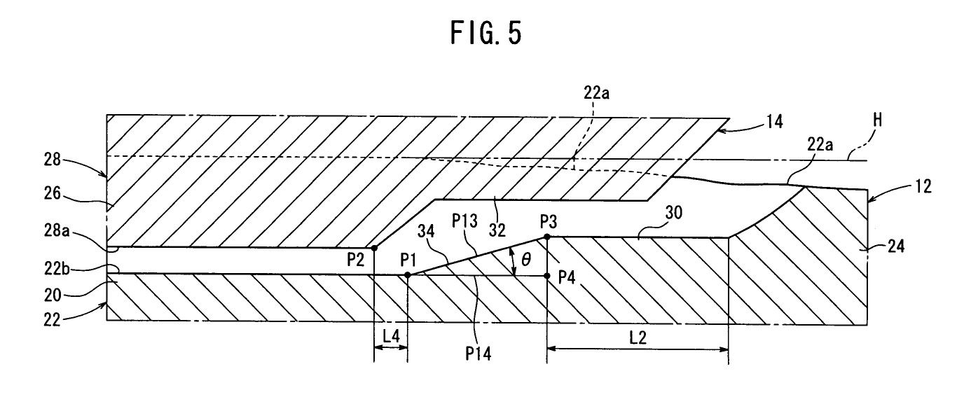

The first step region 30 of the shaft tooth section 22 may have a slanted surface or an arcuate curved surface having a predetermined radius of curvature or a composite surface composed of a slanted surface and a curved surface. The peak 22a of the shaft tooth section 22 has an outside diameter which may remain constant in the axial direction, as shown in FIGS. 3 and 4, or which may progressively decrease (the tooth height may decrease) from an area close to the point P1 toward the shaft shank 24, as shown in FIG. 5. With the outside diameter of the peak 22a progressively decreasing toward the shaft shank 24, the shaft tooth section 22 can easily be manufactured by rolling racks, not shown, and the function of the shaft tooth section 22 to transmit rotary torque is free of any problems. In FIG. 5, the reference character “H” represents a horizontal line to be compared with a change (reduction) in the outside diameter of the peak 22a.

On the peak 28a of the hub tooth section 28, there is established a point P2 which is offset a predetermined distance L4 from the point P1 in the shaft tooth section 22 in a horizontal direction away from the shaft shank 24. From the point P2, the peak 28a changes its peak diameter φ3 to a peak diameter φ4, providing a second step region 32 with the peak diameter φ4. The second step region 32 extends a predetermined distance L3.

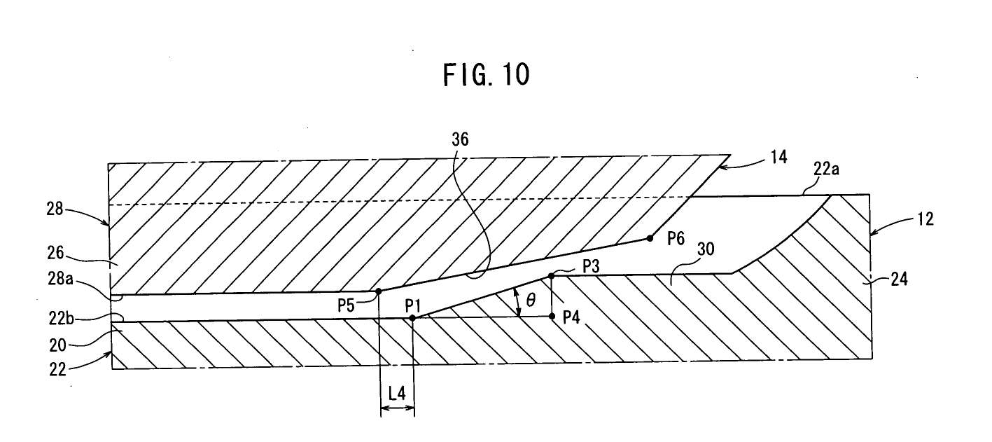

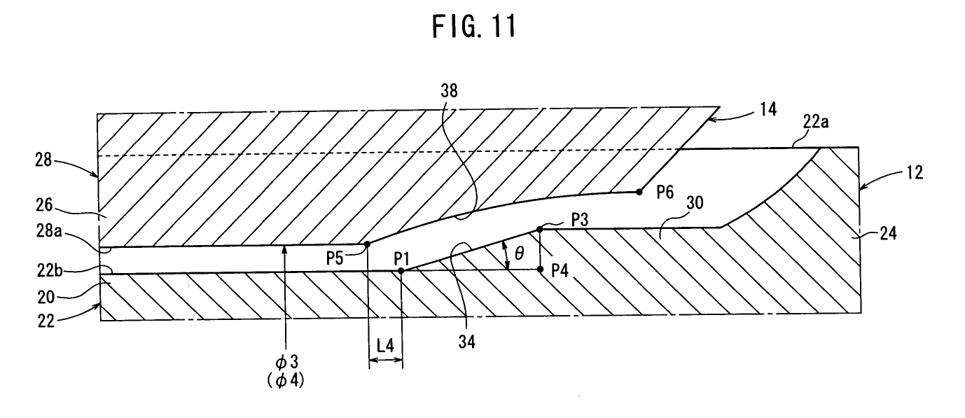

The second step region 32 of the hub tooth section 28 may have a slanted surface 36 (see FIG. 10) or an arcuate curved surface 38 (see FIG. 11) having a predetermined radius of curvature or a composite surface composed of the slanted surface 36 and the curved surface 38, and may be of a shape different from the shape of the first step region 30. The tilt angle of the second step region 32 is set as desired corresponding to the tilt angle of the first step region 30. The shape of the hub tooth section 28 is not limited to the shape of the second step region 32, but may include a round shape having a predetermined radius of curvature, a tapered shape, or the like. The valleys 28b of the hub tooth section 28 have an inside diameter which remains constant in the axial direction.

The valley diameters φ1, φ2 represent respective distances from the central axis of the shaft 12 to the bottom lands of the valley 22b of the shaft tooth section 22. The peak diameters φ3, φ4 represent respective distances from the central axis of the shaft 12 to the top lands of the peak 28a of the hub tooth section 28.

The distance L2 in the shaft tooth section 22 may be set to a value greater than the distance L1 (L1<L2) in order to establish different major load transmitting regions for transmitting different loads including a low load, a medium load, and a high load, for example, depending on the magnitude of the load applied to the area where the shaft tooth section 22 and the hub tooth section 28 mesh with each other. The distance L2 in the shaft tooth section 22 and the distance L3 in the hub tooth section 28 may be set to substantially equal values (L2=L3), or the distance L3 in the hub tooth section 28 may be set to a value greater than the distance L2 in the shaft tooth section 22 (L2<L3), for allowing an offset (described later) to be easily established depending on dimensional tolerance and dimensional accuracy and also for more easily assembling the shaft 12 and the hub 14 together.

As can be seen from FIG. 3, the point P1 as a starting point (changing point) where the first step region 30 of the shaft tooth section 22 starts to rise and the point P2 as a starting point (changing point) where the second step region 32 of the hub tooth section 28 starts to rise are offset substantially horizontally from each other by a predetermined distance L4.

Therefore, when rotary torque is applied to the shaft/hub unit 10 of the shaft 12 and the hub 14 wherein the shaft tooth section 22 and the hub tooth section 28 mesh with each other, since the point P1 in the shaft tooth section 22 and the point P2 in the hub tooth section 28 are offset from each other by the given distance, the stresses imposed on the shaft/hub unit 10 are distributed to the points P1, P2, thereby relaxing stress concentration.

If the point P1 and the point P2 are not offset from each other, then the stresses applied to the unit 10 are liable to concentrate excessively on a region where the point P1 and the point P2 are identical or substantially identical radially to each other. As a result, according to the present embodiment, since the stress concentration is reduced and distributed, the static mechanical strength and fatigue strength of the area where the shaft tooth section 22 and the hub tooth section 28 mesh with each other are increased.

In FIG. 4, a right-angled triangle formed by interconnecting points P1, P3, P4 may have its cross-sectional area increased, and the angle θ formed between a line segment P14 interconnecting the points P1, P4 and a line segment P13 interconnecting the points P1, P3, i.e., the tilt angle θ of the first step region 30, may be set to a predetermined value for further relaxing stress concentration with a tapered surface 34 of the first step region 30.

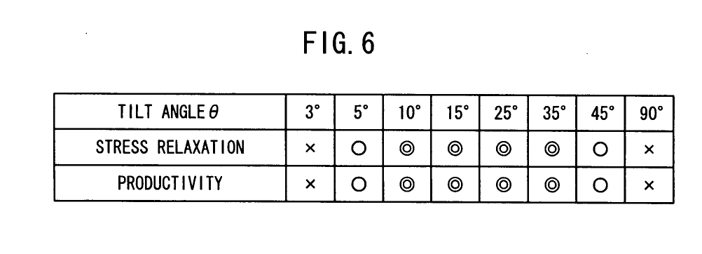

The relationship between the tilt angle θ of the first step region 30, stress relaxation, and productivity is shown in FIG. 6. It can be seen from FIG. 6 that stress relaxation and productivity are good (see symbol “◯”) if the tilt angle θ is set to a value in the range from 5 degrees to 45 degrees, and optimum (see symbol “⊚”) if the tilt angle θ is set to a value in the range from 10 degrees to 35 degrees.

If the tilt angle θ is set to 3 degrees, no sufficient stress distribution capability is available, and it is difficult to manufacture the shaft tooth section 22 with rolling racks. If the tilt angle θ is set to 90 degrees, excessive stresses are concentrated on the step-like first step region 30, and the durability of rolling racks is deteriorated.

An ordinary shaft/hub spline fitting arrangement which is free of the first and second step regions 30, 32 has a stress peak point produced in the vicinity of the shaft shank. According to the present embodiment, however, the first step region 30 is provided in the shaft tooth section 22 to allow some stresses to concentrate on the point P1, thus distributing stresses that tend to concentrate on the shaft shank 24. If the tilt angle θ of the first step region 30 in the shaft tooth section 22 is set to a value that is too large, e.g., 90 degrees, for example, then excessive stresses concentrate on the point P1, failing to provide a stress distributing (stress relaxing) capability. By setting the tilt angle θ, i.e., the rise angle, of the first step region 30 to an appropriate value, the concentration of stresses in the vicinity of the shaft shank 24 is suitably distributed to reduce stresses at the peak point.

FIGS. 2A and 2B show the manner in which the twisted peaks 22a of the shaft tooth section 22 and the straight peaks 28a of the hub tooth section 28 are held in mesh with each other when rotary torque is applied to them in their unloaded state. It is assumed that when rotary torque is applied to the peaks 22a, 28a, a load is applied to them in the direction indicated by the arrow Y which is perpendicular to the axis of the hub tooth section 28. In FIG. 2A, the imaginary lines represent an inversely twisted shape of the peak 22a of the shaft tooth section 22 which is inclined in the opposite direction.

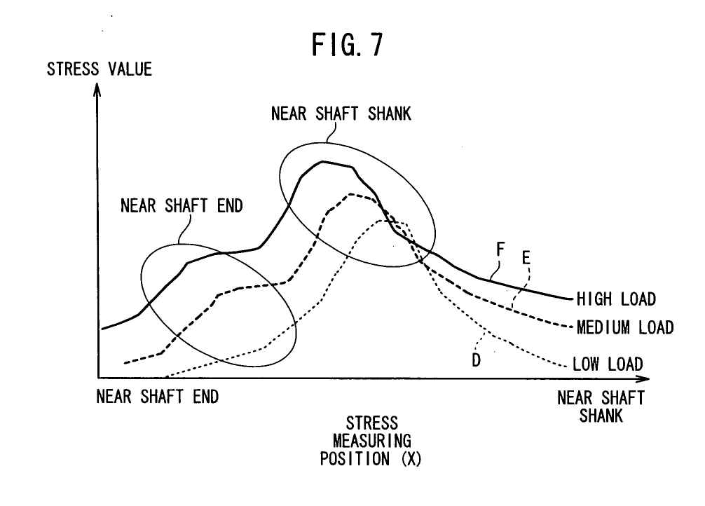

FIG. 7 shows the relationship between stress values and positions where the stresses are measured (see the arrow X in FIG. 2B). It can be seen from FIG. 7 that as the magnitude of an applied load varies, the peak point of stresses changes along the measured positions. If the magnitude of the applied load varies through three stages, i.e., a low load, a medium load, and a high load, then characteristic curves that are plotted under those loads include a low-load characteristic curve D, a medium-load characteristic curve E, and a high-load characteristic curve F, respectively.

As can be understood from FIG. 2B, the areas where the shaft tooth section 22 and the hub tooth section 28 mesh with each other successively change, i.e., a circular area a, a circular area b, and a circular area c corresponding respectively to load-applied positions, depending on the magnitude of the applied load. The areas in which the shaft tooth section 22 and the hub tooth section 28 mesh with each other are displaced away from the center toward the end 13 and the shaft shank 24 of the shaft 12 depending on the magnitude of the applied load.

Specifically, when the low load is applied, the circular areas a closer to the end 13 and the shaft shank 24 of the shaft 12 serve as major low-load transmitting areas. When the medium load is applied, the circular areas b closer to the end 13 and the shaft shank 24 of the shaft 12, which are displaced slightly from the circular areas a, serve as major medium-load transmitting areas. When the high load is applied, the circular areas c closer to the end 13 and the shaft shank 24 of the shaft 12, which are displaced slightly from the circular areas b, serve as major high-load transmitting areas.

With the shaft tooth section 22 being thus of a twisted shape crossing the axis of the hub tooth section 28, the area where the load is transmitted (the peak point of stresses) changes depending on the magnitude of the applied load, thus relaxing the concentration of stresses on particular areas.

As a result, the applied load is distributed toward the end 13 and the shaft shank 24 of the shaft 12 (as can be understood from FIG. 7, the load applied to the shaft shank 24 is greater than the load applied to the end 13 of the shaft 12), and the load is further distributed because the areas closer to the end 13 and the shaft shank 24 of the shaft 12, to which the load is transmitted, change depending on the magnitude of the applied load.

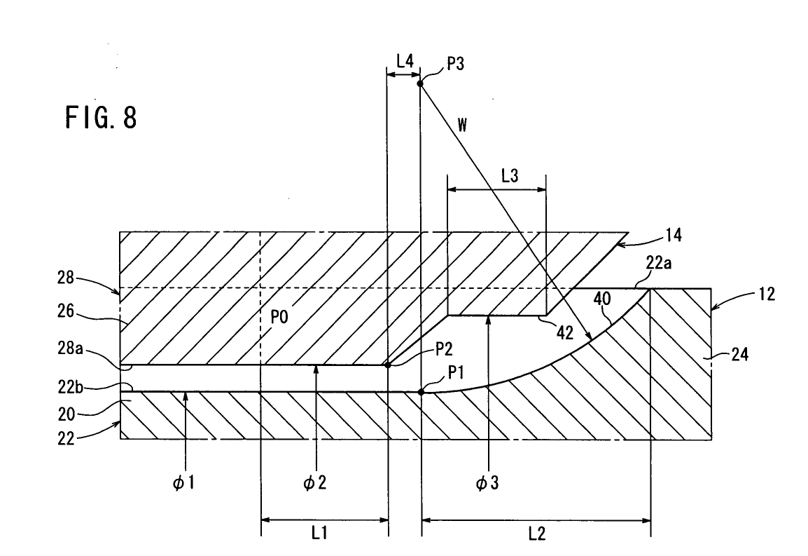

A shaft/hub unit which incorporates a power transmitting mechanism according to another embodiment of the present invention is shown in FIG. 8. Those parts of the present embodiment which are identical to those of the above embodiment are denoted by identical reference characters, and will not be described in detail below.

The other embodiment differs in that an arcuate region 40 extends from the point P1 toward the hub tooth section 28 and is joined to the shaft shank 24, the arcuate region 40 having a radius W of curvature from a center P3 of curvature.

A step region 42 of the hub tooth section 28, which is retracted away from the shaft tooth section 22, may have a slanted surface or an arcuate curved surface having a predetermined radius of curvature or a composite surface, for example. The tilt angle of the step region 42 starting from the point P2 is set as desired corresponding to the tilt angle of the arcuate region 40. The shape of the hub tooth section 28 is not limited to the shape of the step region 42, but may include a round shape having a predetermined radius of curvature, a tapered shape, or the like. The valleys 28b of the hub tooth section 28 have an inside diameter which remains constant in the axial direction.

The arcuate region 40 of the shaft tooth section 22 and the step region 42 of the hub tooth section 28 cooperate in distributing stresses applied to the arcuate region 40 of the shaft tooth section 22, thereby relaxing stress concentration.

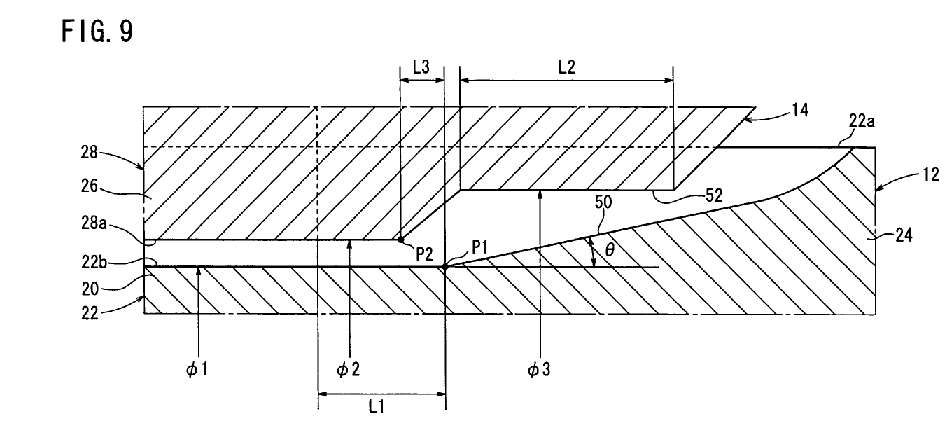

A shaft/hub unit which incorporates a power transmitting mechanism according to still another embodiment of the present invention is shown in FIG. 9.

The still other embodiment differs in that from the point P1, the diameter of the valley 22b is progressively increased toward the hub tooth section 28, providing a tapered region 50 having an angle θ with respect to the horizontal valley 22b. The tapered region 50 extends toward and is joined to the shaft shank 24.

The outside diameter of the peaks 22a of the shaft tooth section 22 is constant and remains unchanged in the axial direction.

On the peak 28a of the hub tooth section 28, there is established a point P2 at a position which is offset a predetermined distance L3 from the point P1 in the shaft tooth section 22 in a horizontal direction away from the shaft shank 24. From the point P2, the peak 28a changes its peak diameter φ2 to a peak diameter φ3, providing a step region 52 with the peak diameter φ3. The step region 52 extends a predetermined distance L2.

The step region 52 of the hub tooth section 28 may have a slanted surface or an arcuate curved surface having a predetermined radius of curvature or a composite surface composed of a slanted surface and a curved surface. The tilt angle of the step region 52 starting from the point P2 is set as desired corresponding to the tilt angle of the tapered region 50. The shape of the hub tooth section 28 is not limited to the shape of the step region 52, but may include a round shape having a predetermined radius of curvature, a tapered shape, or the like. The valleys 28b of the hub tooth section 28 have an inside diameter which remains constant in the axial direction.

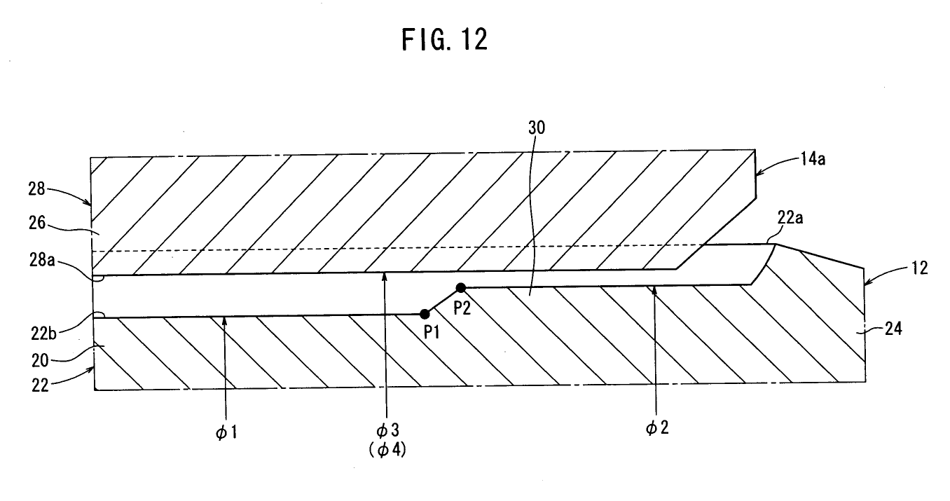

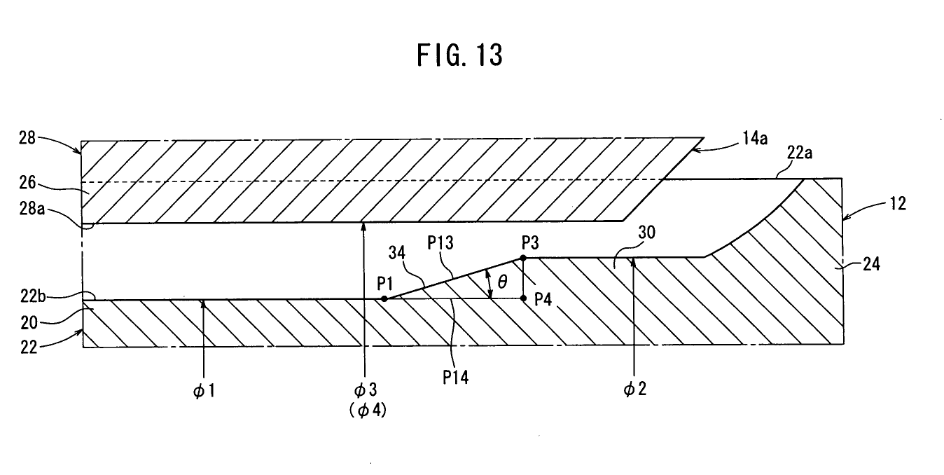

In the embodiments shown in FIGS. 1 through 11, the peak 28a of the hub tooth section 28 changes its peak diameter φ3 to the peak diameter φ4. However, the present invention is not limited to such a structure, but covers hubs 14a having a hub tooth section 28 whose peak diameter φ3 (φ4) is constant, as shown in FIGS. 12 and 13.

1. A mechanism for transmitting power between a shaft and a hub to transmit rotary torque between the shaft and the hub that is disposed around the shaft while holding a shaft tooth section formed on the shaft and a hub tooth section formed on the hub in engagement with each other, wherein
said shaft tooth section has a straight peak having a constant tooth thickness and a valley having a diameter varying from an end toward a shaft shank of the shaft;
said hub tooth section has a straight peak having a constant tooth thickness and a valley having a constant diameter in the axial direction of the shaft;
the axis of the peak of said shaft tooth section crosses the axis of said shaft at a predetermined angle, and the axis of said hub tooth section extends parallel to the axis of said shaft; and
the peak of said shaft tooth section and the peak of said hub tooth section abut against each other at both of an end and the shaft shank of said shaft, thereby distributing and transmitting a load.

2. A mechanism according to claim 1, wherein the peak of said hub tooth section has an inner diameter changing from the end toward the shaft shank; and
a changing point of the diameter of the valley of said shaft tooth section and a changing point of the inside diameter of the peak of said hub tooth section are set in respective positions which are offset by a predetermined distance.

3. A mechanism according to claim 2, wherein said valley of said shaft tooth section has a first step region raised toward said hub tooth section, and said peak of said hub tooth section has a second step region retracted away from said shaft tooth section, and wherein a starting point of said first step region and a starting point of said second step region are set in respective positions which are offset from each other by a predetermined distance.

4. A mechanism according to claim 3, wherein said first step region of said shaft tooth section has a tilt angle set to a value ranging from 5 degrees to 45 degrees.

5. A mechanism according to claim 1, wherein different main load transmitting regions are provided depending on the magnitude of a load applied to an area where said shaft tooth section and said hub tooth section mesh with each other; and
the magnitude of the load selectively represents a low load, a medium load, and a high load, and said main load transmitting regions for transmitting the low load, the medium load, and the high load, respectively, are established in directions spaced successively toward the end and the shaft shank at which the peak of said shaft tooth section and the peak of said hub tooth section abut against each other.

6. A mechanism according to claim 1, wherein the valley of said shaft tooth section has an arcuate region having a predetermined curvature and extending toward said hub tooth section, and the peak of said hub tooth section has a step region facing said arcuate region and retracted away from said shaft tooth section.

7. A mechanism according to claim 1, wherein the valley of said shaft tooth section has a tapered region having a diameter progressively greater toward said hub tooth section, and the peak of said hub tooth section has a step region facing said tapered region and retracted away from said shaft tooth section.
